(19) United States
(12) Patent Application Publication
(10) Pub. No.: US 2007/0183138 A1
(43) Pub. Date: Aug. 9, 2007

(54) Express mount for electrical fixture

(75) Inventor: James A. Cooper, Maitland (CA)

Correspondence Address: NIXON PEABODY, LLP, 401 9TH STREET, NW, SUITE 900, WASHINGTON, DC, 20004-2128, US

(73) Assignee: CANARM LTD., Brockville (CA)

(21) Appl. No.: 11/346,375

(22) Filed: Feb. 3, 2006

(51) Int. Cl. F21S 8/00

(52) U.S. Cl. 362/147; 362/453

(57) ABSTRACT

A system for quickly mounting and grounding electrical fixtures with respect to flush mounted electrical junction boxes is provided. The system comprises an electrically conductive mount bracket for releasably securing on and across the junction box mounted flushly on a support surface. A ground wire to be secured to the electrical fixture is secured to the mount bracket so as to support the weight of the electrical fixture when suspended from the mount bracket by the ground wire. An anchor post is centrally secured to the mount bracket so as to extend outwardly away from the junction box when the mounted bracket is in a secured position on the junction box. An extension post is provided together with an attachment to releasably secure the extension post to the anchor post so that the electrical fixture is releasably supported in operative position on the extension post.

### FIELD OF THE INVENTION

The present invention relates to a system for quickly mounting and grounding electrical fixtures with respect to flush mounted junction boxes, for example, in ceilings or walls of buildings.

### BACKGROUND OF THE INVENTION

Conventionally, such fixtures, including a base on which are a light bulb socket or sockets, and appropriate wiring so that the fixture may be connected to the building's electrical circuitry, are mounted to a mount bracket, in the form of a plate with a plurality of apertures. With the mount bracket secured in position across the junction box, the live and neutral wires from the fixture are secured to corresponding wires within the junction box and the ground wire is secured to either the mount bracket or a mounting terminal within the junction box. The fixture base is then secured to the mount bracket, flushly with the support surface, by screws passing through apertures of the base into aligned, threaded apertures of the mount bracket. A light transmitting cover is then secured, for instance to a post which is secured to the base or in some other fashion to the base, in a conventional fashion.

This system for mounting electrical fixtures to flush mounted junction boxes is both time consuming and awkward, requiring a considerable amount of dexterity if one person is carrying out the task, or a second person to facilitate it.

It is an object of the present invention to provide and improve the system for quickly mounting and grounding electrical fixtures to such flushly mounted junction boxes.

### SUMMARY OF THE INVENTION

In accordance with the present invention, a system for quickly mounting and grounding an electrical fixture with respect to an electrical junction box which is mounted flushly within a support surface is provided. The system comprises an electrically conductive mount bracket for releasably securing on and across the junction box. A ground wire to be secured to the electrical fixture is secured to the mount bracket so as to support the weight of the electrical fixture when secured thereto and suspended from the mount bracket by the ground wire. An anchor post is centrally secured to the mount bracket so as to extend outwardly away from the junction box when the mount bracket is in a secured position on the junction box. An extension post is provided together with means to releasably secure the extension post to the anchor post so that the electrical fixture is releasably supported in operative position on the extension post.

In a preferred embodiment of the present invention, the anchor post is externally threaded and an internally threaded sleeve is secured to an end of the extension post for releasable threaded attachment of the extension post to the anchor post and support of the electrical fixture in operative position.

In another embodiment of the invention, the system additionally includes the fixture to which an end of the grounding wire is secured so as to support the weight of the electrical fixture when suspended from the mount bracket by the grounding wire.

The system according to the present invention permits one person quickly and easily to secure an electrical fixture in position on a flush mounted junction box.

### BRIEF DESCRIPTION OF THE DRAWINGS

These and other objects of the invention will become apparent upon reading the following detailed description and upon referring to the drawings in which:

FIG. 1 is an exploded perspective view of the system according to the present invention, showing the components and their interrelationship;

FIGS. 2a, 2b, 2c, 2d, 2e and 2f are sequential views illustrating the steps of mounting an electrical fixture using a conventional system; and

FIGS. 3a, 3b, 3c and 3d are sequential views illustrating the steps of mounting an electrical fixture using the system of the present invention.

While the invention will be described in conjunction with an illustrated embodiment, it will be understood that it is not intended to limit the invention to such an embodiment. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

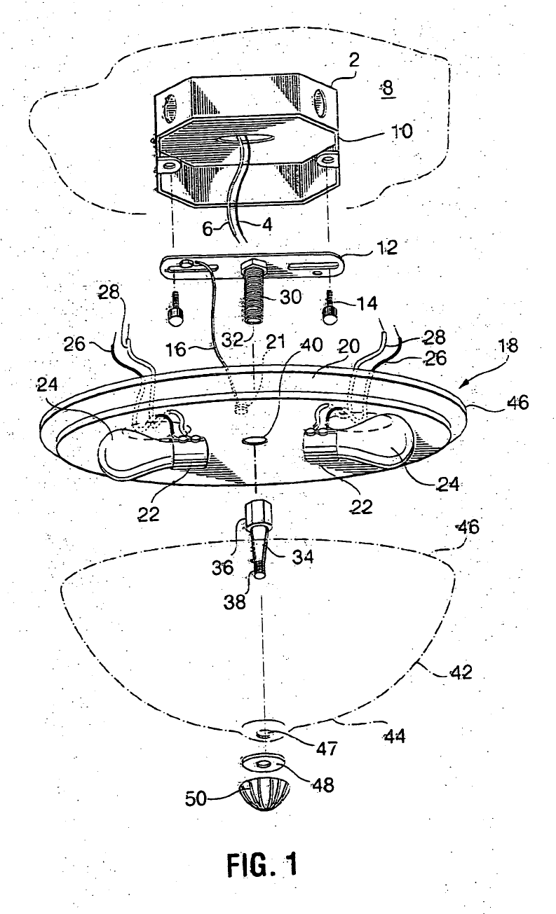

As can be seen in FIG. 1, the components for a system for quickly mounting and grounding an electrical fixture to a junction box 2 are illustrated in exploded fashion. Appropriate live and neutral wires 4 and 6 respectively are already in place, as illustrated, in junction box 2. That junction box is of the type which is flushly mounted within support surface 8, which is preferably a ceiling of a building (but which might also be a wall), in the sense that the peripheral edges 10 of junction box 2 are more or less at the same level as the support surface 8 itself.

The system according to the present invention includes an electrically conductive mount bracket 12 for flushly and releasably securing on and across junction box 2 using conventional mounting screws 14. A grounding wire 16 is secured at one end to the mount bracket 12 and at the other end to the electrical fixture 18 18 on the back of its base 20 for example by rivet 21, so as to support the weight of fixture 18 when suspended from the mount bracket. Sockets 22 for bulbs 24 are provided on the other side of base 20. Appropriate live and neutral wires 26 and 28 respectively are associated with sockets 22, these wires to be connected respectively to wires 4 and 6 within junction box 2 when mounting fixture 18. An extension post 30 is centrally secured to mount bracket 12 to extend outwardly, as illustrated, from the junction box 2 when mount bracket 12 is in secured position with respect to the junction box 2. Anchor post 30 is provided with externally threaded free end 32. An extension post 34 is provided having secured at one end a sleeve 36 with internal screw threads mateably engagable with the external screw threads of anchor post 30. At the other end of extension post 34 are external screw threads 36.

Anchor post 30, when mount bracket is secured in position across junction box 2, extends through aperture 40 in base 20, from the side opposite the side on which sockets 22 are mounted, and sleeve 36 of extension post 34 is then threadably engaged onto end 32 of anchor post 30. Sleeve 36 has a circumference which extends beyond the edges of aperture 40, so as to support base 20 when extension post 34 is thus secured to anchor post 30. A light transmitting cover 42, is provided, illustrated as being a translucent hemisphere, having a top 44 and circular base 46 with an aperture 47 centrally positioned in its top 44 to receive threaded end 38 of extension post 34 so that this end extends beyond cover 42. In this manner, when washer 48 and lock nut 50 are fitted on threaded end 38 and tightened, cover 42 is secured in position for example with its circular base 46 bearing against peripheral portions of base 20.

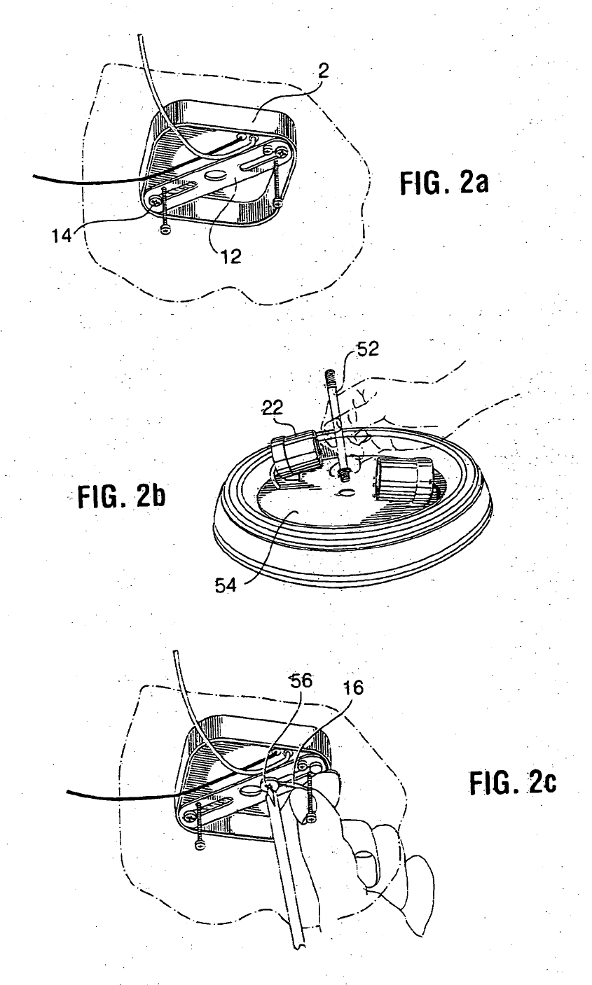

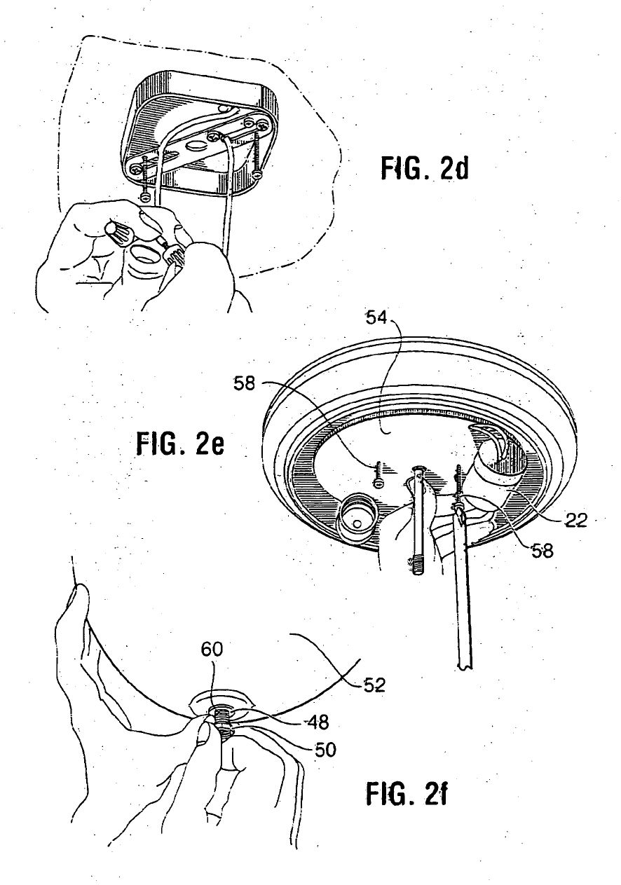

It will be understood that the system according to the present invention simplifies the mounting of electrical fixtures in flush mounted junction boxes 2. Previously, as illustrated in FIGS. 2a to 2f, it was conventional first to secure a mounting bracket 12 in position on junction box 2 using screws 14 (FIG. 2a), then to mount a support post 52 by threadably or otherwise securing it to the base 54 on the same side as sockets 22 (FIG. 2b), to secure ground wire 16 to a terminal connection 56 on mount bracket 12 (FIG. 2c), to connect the live and neutral wires from the fixture to those in the junction box (FIG. 2d), to secure base 54 to mount bracket 12 by means of screws 58 so that base 54 is secured in position on the supporting surface (FIG. 2e) these last three steps are extremely difficult for an individual to carry out using only two hands since the fixture must be somehow supported during these steps and, after the bulbs have been inserted in sockets 22, to place cover 42 in position over base 54 by securing washer 48 and nut 50 over threaded end 60 of extension post 52, which threaded end 60 extends through an aperture in cover 42 (FIG. 2f).

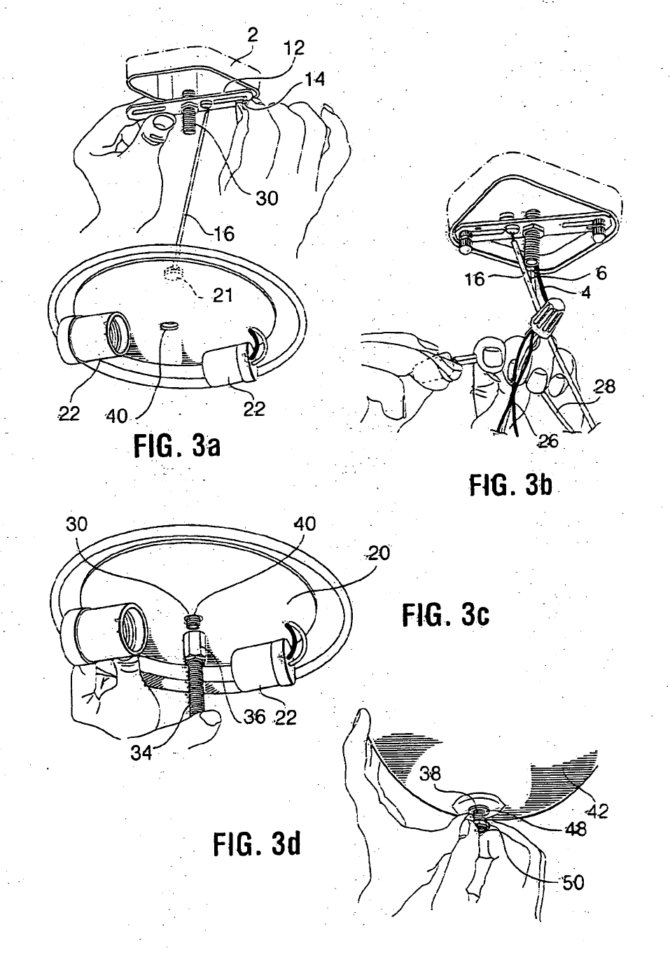

To mount an electrical fixture using the system of the present invention as illustrated in FIGS. 3a to 3d, the mount bracket 12, with anchor post 30 and secured ground wire 16, is secured in position across flushly mounted junction box 2, by means of screws 14 (FIG. 3a). Because anchor post 30 is already in proper position and base 20 is already attached to mount bracket 12 by means of ground wire 16, which ground wire is secured to both bracket 12 and fixture base 20 so as to support the weight of that base and associated sockets 22, the person installing the electrical fixture can use both hands for securing mount bracket 12 in position and does not have simultaneously to support the fixture. As well, ground wire 16 does not have to be connected as a separate step as was conventionally the case. Next, the live and neutral wires 26 and 28 are connected to corresponding wires 4 and 6 in junction box 2 (FIG. 3b), extension post 34 is secured to anchor post 30 by threading sleeve 36 over the threaded end 32 of post 30 extending through aperture 40 in fixture base 20 (FIG. 3c), base 20 being then supported by sleeve 36 in position adjacent the ceiling surface and, after bulbs have been inserted in sockets 22, cover 42 is secured in position over base 20 by tightening washer 48 and nut 50 on threaded end 38 of extension post 34, which threaded end extends through the aperture in the top of cover 42 (FIG. 3d).

The system according to the present invention provides for a faster, more efficient mounting of electrical fixtures over conventional systems, requiring fewer steps, many of which steps are similar to carry out.

Thus, it is apparent that there has been provided in accordance with the invention an flush mount system for electrical fixtures that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A system for quickly mounting and grounding an electrical fixture with respect to an electrical junction box which is mounted flushly within a support surface, the system comprising an electrically conductive mount bracket for releasably securing on and across the junction box, a ground wire, secured to the mount bracket and to be secured to the electrical fixture, so as to support the weight of the electrical fixture when secured thereto and suspended from the mount bracket by the ground wire, an anchor post centrally secured to the mount bracket so as to extend outwardly away from the junction box when the mount bracket is in secured position on the bracket, an extension post and means to releasably secure the extension post and electrical fixture to the anchor post so that the electrical fixture is releasably supported in operative position on the extension post.

2. The system according to claim 1, wherein the anchor post is externally threaded, and an internally threaded sleeve is secured to an end of the extension post for releasable threaded attachment of the extension post to the anchor post, the extension post when so attached supporting of the electrical fixture in operative position.

3. The system according to claim 2, wherein the extension post is externally threaded at a second end of the extension post, which end is to receive a nut for supporting a fixture cover on the extension post.

4. The system according to claim 2, the system including a fixture to which an end of the grounding wire has been secured so that, during installation, it will support the weight of the electrical fixture when suspended from the mount bracket by the grounding wire.

5. The system according to claim 4, wherein the extension post is externally threaded at a second end of the extension post, which end is to receive a nut for supporting a fixture cover on the extension post.

6. The system according to claim 5, wherein the electrical fixture comprises one or more light bulb sockets supported on a base, the base to be immediately adjacent the support surface when the fixture is mounted in operative position, an aperture in the base through which the anchor post extends when the fixture is mounted in operative position so that the extension post may be secured thereto, the sleeve associated with the extension post to support the fixture in operative position when the extension post is secured to the anchor post, a light transmitting cover to envelope the light bulb socket or sockets and any light secured therein, the cover having a top and a peripheral edge, the peripheral edge to be adjacent the base when the fixture is mounted in operative position, and an aperture centrally positioned in the cover top, through which aperture the externally threaded end of the extension post extends when the fixture is mounted in operative position, and a nut threadably engage said threaded end of the extension post when the fixture is mounted in operative position and support the cover.

7. The system according to claim 6, wherein the sleeve on the end of the extension post has a peripheral circumference which is larger than the aperture in the base, so that the base is supported on the sleeve when the extension post is attached to the anchor post extending through the base aperture when mounting the electrical fixture.
